(19) United States
(12) Patent Application Publication
(10) Pub. No.: US 2005/0086285 A1
(43) Pub. Date: Apr. 21, 2005

(54) System and method for dynamic distributed data processing utilizing hub and spoke architecture

(76) Inventors: Bala Balasubramanian, Blue Bell, PA (US); Raghu Parthasarathy, Blue Bell, PA (US)

Correspondence Address: Edward Etkin, Esq., Suite 3C, 4804 Bedford Avenue, Brooklyn, NY, 11235, US

(21) Appl. No.: 10/968,694

(22) Filed: Oct. 18, 2004

Related U.S. Application Data
(60) Provisional application No. 60/512,391, filed on Oct. 17, 2003.

(51) Int. Cl. G06F 15/16

(52) U.S. Cl. 709/200

(57) ABSTRACT

The inventive system provides a distributed data processing system for performing data-related task implemented with a scalable hub and spoke architecture. The advantageous hub-and-spoke architecture comprises a central “hub” system site connected, through one or more high speed communication links, to one or more spoke systems, each of which may be located at a remote spoke system (which may be geographically dispersed from one another). While some information technology infrastructure is necessary for both the hub and the spoke systems, the expensive data processing and control systems, for implementing the majority of the system architecture, and where the majority of automated processing occurs, are concentrated at the hub location. Thus, most of the critical data processing activities are centralized at the hub system, while other activities that either must be performed, or are advantageous to be performed at a particular remote location, are executed by one or more spoke systems. Information generated from localized spoke system operations is transmitted to the hub system through communication links and other types of data or requested work can likewise be readily transmitted from the hub system to one or more spoke systems in real time.

### CROSS REFERENCE TO RELATED APPLICATIONS

The present patent application claims priority from the commonly assigned U.S. Provisional Patent Application 60/512,391 entitled “SYSTEM AND METHOD FOR DYNAMIC DISTRIBUTED DATA PROCESSING UTILIZING HUB AND SPOKE ARCHITECTURE” filed Oct. 17, 2003.

### FIELD OF THE INVENTION

The present invention relates generally to a data processing system for implementation of a scalable distributed hub and spoke architecture for performing various tasks, and more particularly to a data processing system for performing and controlling data acquisition and processing operations through a centralized system connected to one or more remote sub-system sites over a communication network

### BACKGROUND OF THE INVENTION

Most organizations that engage in large scale transaction, document, and other data processing operations typically utilize a straightforward approach of building a data-processing center with data acquisition (e.g., scanners, encoders, etc.) and/or data entry equipment, connected through a local area network to a local data processing system (for example consisting of one or more computer network servers) residing in the same center. For example, lockbox service providers—companies that are involved in check and payment processing—utilize data transports for reading payment stubs and checks and then transmit captured images, through a local database server, to local data entry workstations for data entry by appropriate personnel.

It is well recognized that in any data-processing operation, there are several target goals, with individual priorities thereof being dependent on the organization (or particular customers in the case of data processing service providers), and with
1) Minimize cost per transaction;
2) Minimize “per transaction” processing time;
3) Ensure data integrity;
4) Ensure data security;
5) Minimize transaction errors;

In addition, data processing service providers have the following additional target goals:
6) Maximize transaction volume;
7) Maximize geographic footprint of data processing operations

The pursuit of these target goals is made more difficult by the fact that achieving some of the goals by an organization, has a direct negative impact on the organization's ability to reach certain other goals. For example, it is clear that ensuring data integrity and security will certainly increase the per-transaction costs. As a result, most organizations face the unenviable task of prioritizing the target goals and having to make certain sacrifices.

In recent years, given the proliferation of powerful computer and imaging systems, many organizations engaged in data processing operations (e.g., financial institutions, government agencies, lockbox service providers, etc.), as well as organizations that utilize data processing services peripherally (e.g., most types of companies, government agencies, and other organizations such as non-profit entities) have made significant investments in information technology to automate and otherwise improve their work processes in attempts to meet at least some of the above target goals.

In addition to investments in data acquisition and processing technology, many large, multi-site service providers have attempted to increase the scale of operations by developing extended data processing networks consisting of independent data processing sites in multiple geographic locations. For example, for lockbox service providers, these large geographically dispersed networks ensured a means to provide data processing services close to customers' geographical collection zones, and thus leverage the advantages of a single vendor with a nationwide reach to attract additional business (i.e., meeting target goal #7). Similarly, with regard to government agencies, and especially law enforcement agencies, such as the FBI, satellite data collection centers have gained increased utilization as matter of information gathering necessity rather than business goals.

To further reduce the per-transaction costs, many organizations have turned to building the data processing centers in areas where the labor costs are low, or have outsourced operations to external off-shore data processing centers located in regions where the labor costs are very low. Acquired data is transmitted to such centers in batch form for processing, and processed transactions are then returned, also in batch form.

However, implementation of geographically dispersed processing center strategies, forced organizations into an undesirable time consuming and costly pattern of technology replication. As each new data processing location is added to the network, the investment in information technology must be more or less replicated for each site, with each new site requiring a full complement of the latest data processing equipment (for example, everything from data capture devices and transports to data entry stations, data processing servers, and printers) similar to other sites in the network. This pattern of replication meant that an increase in the scale of operations did not translate into a significant reduction in cost, because the “cost per transaction” is substantially similar in parallel data processing sites. In essence, data processing service providers and other organizations engaged in significant geographically distributed data processing have not been able to take advantage of “economics of scale”.

Another challenge for organizations engaged in data processing has been the negative impact on the per-transaction cost by regular system maintenance and upgrade operations. Regularly performed tasks such as system maintenance, software updates, and across-the-board management of business process or policy changes create significant logistical difficulties and expenses when they must be repeated for each data processing center separately. Another problem facing multiple independent data processing centers is inability to optimize manpower and processing loads—while one data processing center may be overwhelmed with work, another center may be operating at 50% capacity.

Some data processing service providers have attempted to solve at least a portion of the above problems by building data-collection only centers where data collection is accomplished at a local center, and results are batch transmitted to another full-scale processing center equipped with a data processing server on a scheduled (for example, daily) basis. However this approach suffers from a number of disadvantages. While the data-collection only centers are lower cost than full-scale centers, the batch processing methodology slows down the work flow, causing delays of a day or more before data can be entered and processed. Also, batch processing makes detection and correction of errors or problem significantly more slow and difficult. Furthermore, tracking of activities and transactions at the data-collection only centers becomes problematic as batch processing does not give a true measure of real-time performance. Finally, rather that continuously processing data, data processing centers that receive data in batches alternate between idling and being overloaded with large batches of data received from multiple sites, lowering their overall performance.

Finally, aside from localized parallel processing computer systems, there have been no advantageous solutions for utilizing geographically distributed systems to perform data processing intensive tasks outside of lockbox and remittance/document management services.

It would thus be desirable to provide a system and method for implementing a scalable dynamic architecture for performing and controlling data acquisition and processing operations through a centralized hub connected to one or more dispersed satellite sites through one or more communication links. It would also be desirable to provide a system and method for adding additional satellite sites to the centralized hub quickly and at a reduced cost. It would further be desirable to provide a system and method for workflow management and for optimization, distribution, and leveling of task and system loads across multiple satellite sites including failsafe operations. It would additionally be desirable to provide a system and method for facilitating and implementing, from the centralized hub, changes in system functionality and business policies, and performing maintenance and upgrade operations, throughout all satellite sites.

### BRIEF DESCRIPTION OF THE DRAWINGS

In the drawings, wherein like reference characters denote corresponding or similar elements throughout the various figures:

FIG. 1 shows a block diagram of a first embodiment of the inventive distributed data processing (DDP) system utilizing novel hub and spoke architecture;

FIG. 2 shows a block diagram of an exemplary embodiment of a spoke system element of the inventive DDP system of FIG. 1;

FIGS. 3A and 3B each show block diagrams of additional exemplary embodiments of the spoke system element of the inventive DDP system of FIG. 1;

FIG. 4 shows a block diagram of an exemplary embodiment of a hub system element of the inventive DDP system of FIG. 1;

FIG. 5 shows a block diagram of an exemplary embodiment of spoke handling services provided by the hub system of FIG. 4;

FIG. 6 shows a block diagram of an alternate embodiment of the inventive distributed data processing (DDP) system of FIG. 1 utilizing multiple related spoke system groups as well as a hub system with increased reliability;

FIGS. 7 and 8 shows logic flow diagrams of exemplary processes that may be a part of workflow services provided by the hub system of FIG. 4;

FIG. 9A shows a logic flow diagram of an exemplary dynamic bandwidth management service process that may be a part of hub services provided by the hub system of FIG. 4; and

FIG. 9B shows a logic flow diagram of an exemplary intelligent expertise-based workflow assignment service process, that may be a part of hub services provided by the hub system of FIG. 4.

### SUMMARY OF THE INVENTION

The present invention is directed to a distributed data processing (DDP) system and method for performing one or more data-related tasks that is implemented with a scalable hub and spoke architecture. The advantageous novel hub-and-spoke architecture comprises a central “hub” system connected, through one or more communication links, to one or more corresponding spoke systems, each of which may be located at a remote spoke site (which may be geographically dispersed from one another).

While some information technology infrastructure is necessary at both the hub and the spoke systems, the expensive data processing, data storage, and operations control and management systems, for implementing the majority of the system architecture, are concentrated at the hub location which also serves as a central point where the majority of automated processing occurs. Thus, most of the critical data processing and system control and management activities are centralized at the hub system, while other activities that either must be performed, or are advantageous to be performed, at a particular remote location, are executed by one or more spoke systems connected to the hub system via communication links that enable transmission, of data gathered or generated from localized spoke processing, to the hub system therethrough Additionally, any non-mandatory spoke operations may be performed by the hub system, from interfaces located at the spoke systems, and using data and resources of the hub system.

Such operations are preferably carried out through remote clients at each spoke system, or as part of an overall distributed platform independent run-time framework that enables and facilitates the hub and spoke architecture by retaining an even greater amount of infrastructure at the hub system.

Preferably, the operations of the DDP system necessary to carry out one or more target tasks for which the DDP system is intended, are substantially conducted in form of “services” performed by one or more of the components of the hub and/or spoke systems.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### DETAILED DESCRIPTION OF PREFERRED EMBODIMENTS

The system and method of the present invention remedy the disadvantages of previously known multi-site data processing systems. The inventive system utilizes a hub-and-spoke architecture comprising a central “hub” system connected to a series of dispersed “spoke” satellite systems through one or more communication links. This approach ensures that the expensive and difficult to maintain data processing, data storage, and operations control and management systems, for implementing the majority of the system architecture, are concentrated in the hub system which also serves as a central point where the majority of automated processing occurs.

Thus, most of the critical data processing and system control and management activities are centralized at the hub system, while other activities that either must be performed, or are advantageous to be performed, at a particular remote location, are executed by one or more spoke systems connected to the hub system via communication links that enable transmission, of data gathered or generated from localized spoke processing, to the hub system therethrough Additionally, any non-mandatory spoke operations may be performed by the hub system, from interfaces located at the spoke systems, and using data and resources of the hub system.

This architecture enables an advantageous combination of the best features of centralized and distributed data processing. Essentially, various functions of the overall data processing system can be dynamically distributed across multiple remote (e.g., geographic) locations as required, for example through use of automated or manual load balancing. This also enables optimization of manpower utilization across the entire enterprise. For example, a lockbox service provider can route images or other information for data entry to a different spoke system through which the images were acquired, if the different spoke system is operating below standard capacity. This can be especially advantageous if a particular spoke system is experiencing technical difficulties. Accordingly, although it may be geographically dispersed, the inventive system functions as if the hub and the spoke systems were interconnected via a local area network.

The inventive system has many additional advantages. For example, the system is readily scalable—additional spoke systems in new locations, and/or with new functionality may be quickly and easily added at a relatively low information technology investment cost. The new systems can then immediately take advantage of the latest software, business and policy procedures through the hub system. In addition, the inventive system enables implementation, and propagation from the centralized hub system, of changes in software and business policies, and performance of maintenance and upgrade operations, throughout all satellite systems.

Accordingly, the advantageous hub and spoke architecture enables organizations to expand their geographic footprint quickly and at a relatively low cost, and or to add new system capabilities, by readily adding spoke systems to a hub system as necessary, or by expanding or upgrading the hub system. And since spoke systems require much less investment than a hub system, expansion of spoke system from a single hub lowers the cost per transaction, thus simultaneously accomplishing both goals of geographic expansion and lowering of cost per transaction. Furthermore, the flexibility of the hub and spoke architecture of the inventive system enables simplified modification of the entire hub and spoke network for re-engineering, upgrading or other system changes.

While the inventive system is described below in connection with certain drawing figures as an exemplary embodiment advantageously configured for image/data entry processing, it should be understood to one skilled in the art, that the inventive system may be readily and advantageously utilized for distributed processing of any form of data, whether imaging, computational, or transaction-based, without departing from the spirit of the invention as a matter of necessity or design choice. Furthermore, while only basic exemplary physical configurations of the inventive system and its components are shown in the drawings, it should be noted that the inventive system can be readily implemented in any computer system having a centralized processing component and one or more additional satellite components connected to the centralized processing component via high speed communication links.

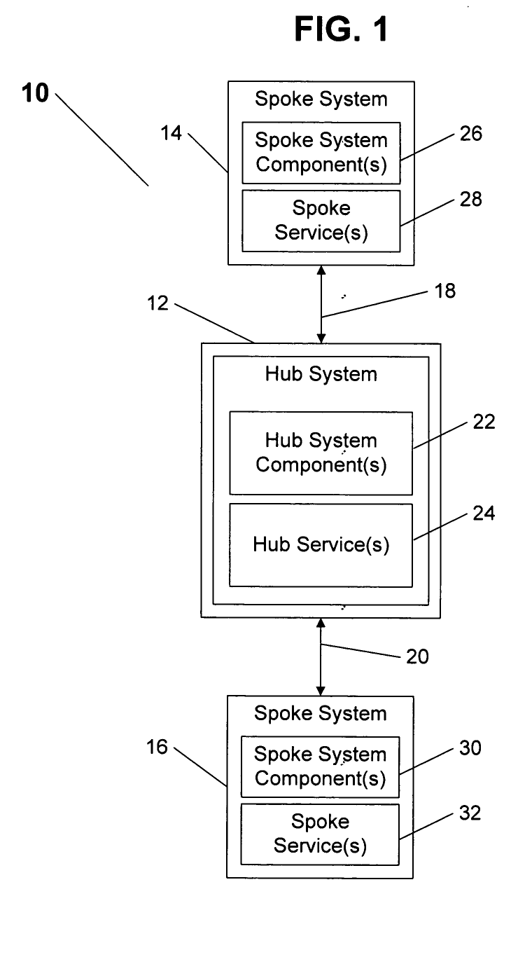

Referring now to FIG. 1, a first exemplary embodiment of an inventive distributed data processing system is shown as a DDP system 10. The DDP system 10 includes a central hub system 12, and a set of two remote satellite spoke systems 14 and 16 connected thereto via respective communication links 18, 20.

Before describing the inventive DDP system 10, its components, infrastructure, and operation in greater detail, it would be helpful to provide the definitions of various terms used herein and in the various drawings figures. Because the currently used terminology that may be utilized to describe the DDP system 10 and its functionality, evolves and changes rapidly, for the purposes of clarity, and without departing from the spirit of the invention, the various elements and components of the inventive DDP system 10, as well as implementations of the advantageous inventive DDP system 10 functions, have been described in terms of their desired or required functionality and/or objectives they are intended to accomplish in accordance with the present invention, rather than as specific physical implementations, which may change with advances in information systems technology. Under each term, information relating to the location and identification of specific use of that term in the enclosed drawing figures is also provided.

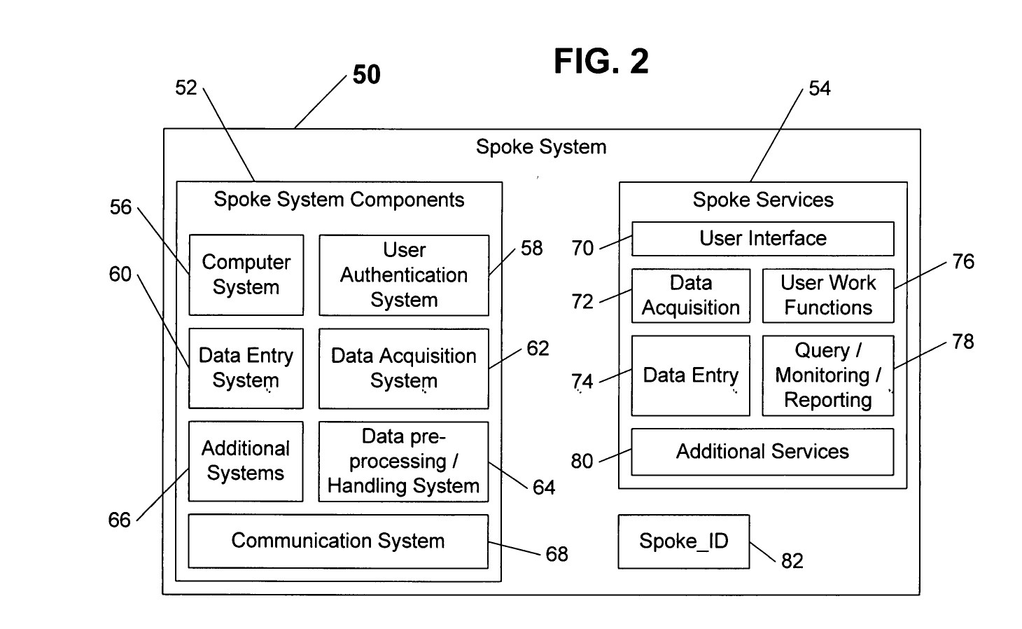

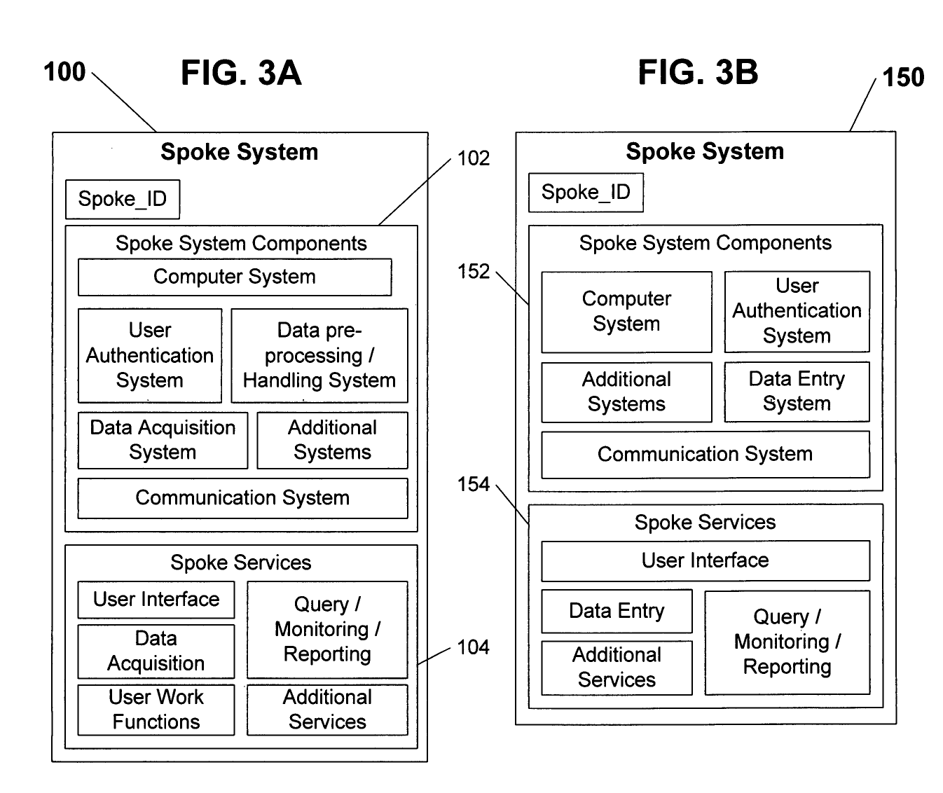

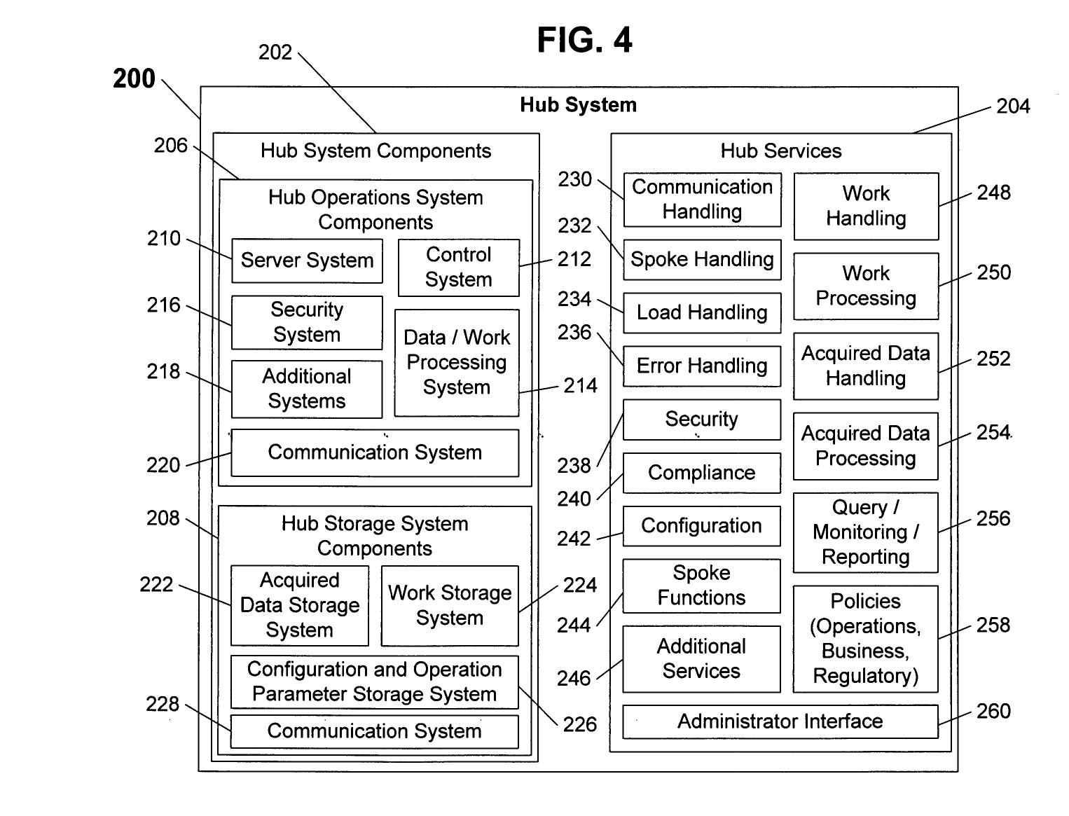

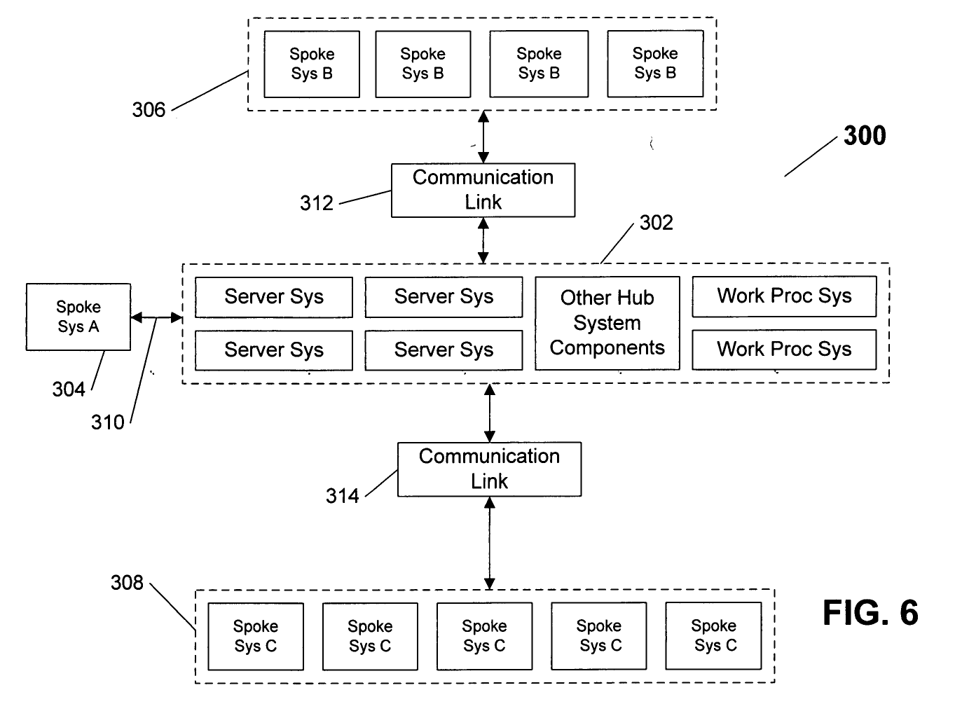

TABLE 1
(Terms and Definitions)

| Term | Definition |
|---|---|
| DDP System | The inventive distributed data processing system |
| (DDP System 10, | (hereinafter the “DDP system”), is preferably designed and |
| FIG. 1) | configured to perform a one or more target tasks, and |
| (DDP System 300, | includes a hub and at least one spoke that communicate |
| FIG. 6) | with one another through corresponding communication |
| | links. The DDP system of the present invention distributes, |
| | to one or more particular spokes, data-related operations |
| | that are advantageous to perform locally at that spoke, |
| | while maintaining all control, management, bulk |
| | processing, data storage and other system operations |
| | centralized at the hub. |
| Target Task | The target task for a DDP system may be any operation |
| (All FIGS.) | that involves one or more of the following activities: data |
| | acquisition, data processing, data analysis and data |
| | modification, to accomplish is goal. A target task for a |
| | particular DDP system may change from time to time (for |
| | example, in military, law enforcement, medical, or scientific |
| | applications), or it may be a continual part of an |
| | organization's business operations (for example, for |
| | companies engaged in lockbox services, financial |
| | transaction processing, or consumer order processing). |
| | The target task may be a singe operation, or it may consist |
| | of multiple target sub-tasks (for example, a lockbox service |
| | target task involves check image acquisition, analysis, |
| | transaction data entry and verification, and may also |
| | involve review, modification, and processing of the entered |
| | financial transactions). |
| Data | For the purposes of DDP system, data is any type of |
| (All FIGS.) | information in any number for formats which may be |
| | acquired, entered, analyzed, modified, reviewed, and/or |
| | processed in the course of performing the target task by |
| | the DDP system. For example, depending on the target |
| | task and the DDP system, data may include, but is not |
| | limited to one or more of the following: scanned images |
| | (documents, financial instruments, etc.), photographs, |
| | captured or recorded audio and/or video, financial/ |
| | business transactions, records (law enforcement, |
| | business, government, scientific, medical, etc.), instrument |
| | or sensor readings (e.g., medical, scientific, military), |
| | executable programs and supporting files, etc. The |
| | different types of data may exist in more or more various |
| | data formats, depending on the nature of the target task |
| | and the type of data, that may include, but are not limited |
| | to: images, audio, and/or video - in analog or digital form, |
| | paper documents, numeric, electronic documents/files |
| | (e.g., databases, spreadsheets, text), program code, etc. |
| Work | Work refers to any actions and/or operations, involving |
| (FIGS. 2-5, 7, 8, and 9B) | one or more types of data that must be performed at one |
| | or more of the spokes and at the hub during operation of |
| | the DDP system to accomplish the target task. Thus, for |
| | example, depending on the type of the target task or tasks |
| | and the DDP system infrastructure, work may involve one |
| | or more of the following: data acquisition, analysis, |
| | modification, review, entry, and/or processing. |
| Hub System | The hub system is comprised of one or more physical |
| (Hub System 12, | information system components (forming a core part of the |
| FIG. 1) | DDP system infrastructure) that are present at the hub and |
| (Hub System 200, | that are selected and configured to perform desired Hub |
| FIG. 4) | Services and that are optionally optimized for centralized |
| (Hub System 302, | operations, such as one or more of the following: control, |
| FIG. 6) | management, data processing, security, work processing, |
| | and data/work storage. |
| Hub | The hub is a central site where the hub system resides |
| (All FIGS.) | embodying the majority of the processing, management |
| | information system infrastructure of the DDP system. |
| Spoke System | The spoke system is one or more physical information |
| (Spoke Systems 14, | system components (forming a satellite part of the DDP |
| 16, FIG. 1) | system infrastructure) that are present at a spoke, that are |
| (Spoke System 50, | selected and configured to perform one or more spoke |
| FIG. 2) | services to support one or more of designated purposes of |
| (Spoke System 100, | the spoke (for example: data acquisition, data entry, data |
| FIG. 3A) | analysis, or data modification), and that are optionally |
| (Spoke System 150, | optimized for performing such services. |
| FIG. 3B) | |
| (Spoke Sys A 308, | |
| Spoke Sys B 324, | |
| 330, Spoke Sys C | |
| 332-340, FIG. 6) | |
| Spoke | The spoke is a satellite site or location (which may |
| (All FIGS.) | optionally be mobile) that includes the spoke system |
| | embodying the specific DDP system infrastructure |
| | necessary for performing one or more specified tasks, |
| | under the control or direction of the hub system, to achieve |
| | the one or more designated purposes of the spoke. |
| System | With respect to each of the hub and spoke systems, |
| Components | depending on their desired functionality and designated |
| (Spoke System | purpose, the various system components may either be |
| Components 26, 30, | implemented as a single physical system (or device) with |
| FIG. 1) | appropriate sub-components (e.g., a computer |
| (Spoke System | workstation), groups of similar physical devices (e.g., a |
| Components 52, | network of computers), and/or as a combination of |
| FIG. 2) | different physical devices (e.g., a network of computers |
| (Spoke System | with biometric ID scanners, data storage device arrays, |
| Components 102, | and communication routing and switching equipment). |
| FIG. 3A) | |
| (Spoke System | Each system component is preferably provided with |
| Components 152, | program instructions (e.g., software), or with equivalent |
| FIG. 3B) | control, configuration, and/or instruction processing |
| (Hub System | features, necessary for its operation and functionality, as |
| Component(s) 22, | well as for its interfacing with other spoke and/or hub |
| FIG. 1) | system components. Optionally, certain system |
| (Hub System | components may be implemented in virtual form as part of |
| Component(s) 202, | the functionality of another component (as described in |
| FIG. 4) | greater detail below in connection with FIGS. 2 to 4) |
| Communication | A communication link refers to any form of a |
| Link | communication connection between the hub system and |
| (Communication | the spoke system(s) that is capable of data transmission |
| Links 18, 20, FIG. 1) | ranging from dedicated telecommunication lines, to a |
| (Communication | wireless broadband links (e.g., satellite uplinks, radio, |
| Links 342, 346, 348, | cellular, wi-fi, etc.), to a communication network, such as a |
| FIG. 6) | LAN (local area network), a WAN (wide area network), or |
| | the Internet. Each type of communication link has different |
| | characteristics that may be taken into account when |
| | selecting a particular type of link for connection between |
| | the hub system and a specific spoke system. These |
| | characteristics include, but are not limited to: data |
| | transmission capacity (i.e., bandwidth), utilization cost, |
| | security, physical parameters, reliability, scalability, etc. |
| Services | Services are the various functions, procedures, and/or |
| (All FIGS.) | actions, that are performed, during the operation of the |
| | DDP system, by one or more of the system components of |
| | the hub and/or spoke systems, automatically, or under the |
| | direction of DDP system users and/or administrators, to |
| | accomplish the target task or tasks. Certain types of |
| | services relate directly to the performance of the target |
| | task (e.g., data entry, data acquisition, data processing), |
| | other types of services may relate peripherally (e.g., |
| | routing of acquired data, data compression, data |
| | validation), while some services may relate to the |
| | operation of the DDP system rather than to a specific |
| | target task (e.g., security, hub/spoke system |
| | configuration, reporting, etc.). Services may be |
| | implemented as system component functions, external |
| | functions (performed from outside the DDP system), |
| | program functions, operating (1) automatically in |
| | accordance with predetermined instructions and/or |
| | settings, (2) semi-automatically under the supervision of |
| | DDP system users and/or administrators, (3) in response |
| | to specific instructions from authorized DDP system users |
| | and/or administrators, or, (4) as a combination of two or |
| | more of the above. |
| Administrator(s) | The DDP system may have one or more administrators |
| (All FIGS.) | responsible for operations of the entire DDP system, or of |
| | certain portions thereof (e.g. the hub system, particular |
| | spoke systems, etc.). Each administrator may have a |
| | different level of authority that governs the extent of |
| | actions that may be taken with respect to the hub and/or |
| | spoke system(s) and/or components thereof. |
| User(s) | The user(s) of the DDP system, which may be located at |
| (All FIGS.) | the spoke and/or at the hub are responsible for performing |
| | the work necessary to accomplish the target task(s) |
| | through one or more of the following: (1) user activities |
| | utilizing one or more of the hub and/or the spoke services |
| | (e.g., data entry, review, and modification), (2) supporting |
| | automated services (e.g., monitoring and maintaining |
| | image scanning system components), or (3) managing hub |
| | and/or spoke services requiring user interaction (e.g., |
| | reporting, technical support for other users, compliance, |
| | etc.). Optionally, each user may have an associated user |
| | record maintained and managed by the DDP system (for |
| | example through one or more authorized administrators) |
| | that may include at least the following information: a |
| | unique user ID, the user's authority level that determines |
| | which DDP system services and/or data the user can view, |
| | control or modify, what type of work is the user qualified to |
| | perform, and other information that the DDP system may |
| | utilize to assign work to the user. |
| Workflow | Workflow is a set of predetermined procedures and rules |
| (All FIGS.) | that govern the services and other operations conducted |
| | by the DDP system during performance of the target task. |
| | For example, in a lockbox service DDP system, workflow |
| | may determine the speed with which particular spoke |
| | systems should be scanning checks, which hub system |
| | component will handle the optical character recognition of |
| | the scanned images, and to which spoke sites should the |
| | images be routed for amount entry and scanline fix. |
| COI | The COI (Centralized Operational Infrastructure) is |
| (All FIGS.) | embodied in a set of cooperating hub and spoke system |
| | services and/or system component functions, for example, |
| | implemented in distributed functional layers (including |
| | applications, clients, interfaces), and supports the |
| | centralized dynamic scalable architecture of the inventive |
| | DDP system. The COI enables and facilitates DDP system |
| | operations (target task-related and otherwise), and is |
| | preferably configured to manage all appropriate DDP |
| | system services and (hub and spoke) system component |
| | functions. In addition to its distributed framework and |
| | infrastructure functionality, the COI may also include (or |
| | interface with) one or more program applications (or |
| | equivalent functionality) that control the overall operation |
| | of the DDP system. Advantageously, the COI may be |
| | interacted with (for example, to access desired system |
| | services) from any portion of the DDP system (e.g., from |
| | spokes or the hub) through one or more “clients” utilizing |
| | an appropriate interface. |

Returning now to FIG. 1, while two spoke systems 14, 16 are shown by way of example in FIG. 1, it should be noted that, as a matter of design choice or necessity, the number of spoke systems that may be utilized with in the DDP system 10, may range from a single spoke system up to a number of spoke systems determined by the maximum operational capacity of the hub system 12. Furthermore, as a matter of design choice, more than one interconnected hub system may be used (not shown) for distributing the without departing from the spirit of the invention.

The physical locations of the spoke systems 14, 16 with respect to the location of the hub system 12 are preferably selected as a matter of design choice depending on such factors as nature, complexity, and scope of the intended DDP system 10 target task(s), as well as on other factors, such as the number and type of corresponding spoke systems, organizational and business strategies and/or policies, and regulatory and/or economic considerations. For example, data acquisition may be advantageous to perform at spoke systems located geographically proximal to the sources of data to be acquired (e.g., check scanning and encoding is advantageous to perform in regions where the checks are collected). In another example, it is advantageous to locate spoke systems configured for data entry in regions with low labor costs, but security regulations may prohibit the spoke systems from being located overseas.

The communication links 18, 20 may be of the same type, or of different types as a matter of design choice or convenience. For example, the links 18 and 20 may both be the Internet, or alternately, the link 18, may be the Internet, while the link 20 may be a secure direct communication line.

The hub system 12 includes one or more hub system components 22, selected and configured to provide hub system service(s) 24, along with any additional necessary hub system 12 components for supporting the portion of the COI (see Table 1 above) that is implemented at the hub system 12, to enable performance of the target task(s), and of supporting day-to-day DDP system 10 operations. For example, the hub system components 22 may include one or more servers for conducting and managing DDP system 10 operations, communication routers for communicating with the spoke systems 14, 16 via the respective communication links 18, 20, and storage servers for storing data and work received from the spoke systems 14, 16. Optionally, the hum system components 22 and services 24 may also include spoke system/services functionality, for example for emergency purposes. Exemplary embodiment of the hub system 12, hub system components 22, and hub services 24, are described below in connection with FIG. 4.

Thus, the hub system 12 is preferably configured (for example, through selection and configuration of appropriate hub system services 24, and selection and configuration of corresponding hub system components 22), and scaled as a matter of design choice depending on the nature, complexity, and scope of the intended DDP system 10 target task(s), as well as on other factors, such as the number and type of corresponding spoke systems, organizational and business strategies and/or policies, and regulatory and/or economic considerations.

Each of the spoke systems 14, 16 includes respective spoke system components 26, 30, selected and configured to provide respective spoke system service(s) 28, 32, along with any additional necessary spoke system 14, 16 components for supporting the portion of the COI that is implemented at each respective spoke system 14, 16. Thus, the composition, configuration, and functionality of each of the spoke system component(s) 26, 30 depend on the designated purpose of each particular spoke system that the particular spoke system is expected to provide to the hub system 12 (and optionally to other spoke systems)).

In one example, the spoke system 14 may include a large local area network with many interconnected computers and data entry terminals, while the spoke system 16 may include a network of high speed image scanners and encoders connected to a single computer system. In certain applications (for example, military, law enforcement, and/or scientific) it may be advantageous for one or more of the spoke systems to be mobile, rather that located at a stationary spoke site. For example, the spoke system 14 may include data collection (e.g., surveillance) system components 26, while the spoke system 16 may be a single computer (for example, ranging in scale from a personal digital assistant device to a workstation) having system components capable of displaying, to the user, information collected by the spoke system 14 and processed by the hub system 12.

The key requirements for the novel hub system 12 and the novel spoke systems 14, 16, are ensuring that the spoke system components 26, 30 and system services 28, 32, as well as the hub system components 22 and the hub system services 24, are sufficient, in conjunction with one another, to support the necessary COI implementation to provide, at the very least, appropriate designated spoke services (e.g. data acquisition, data entry, etc.), centralized data processing operations management (including spoke handling functionality and communication), and storage of both acquired and processed data., and workflow management (for example, control of the flow of data acquired at one or more spokes, the flow of data to be processed to specific spoke or spokes, and the flow of processed data to specific components of the hub system 12 for further processing and/or storage).

Thus, in essence, in accordance with the present invention, each particular spoke system 14, 16 may be supplied with the minimum information system infrastructure (i.e., spoke system components 26, 30 and corresponding services 28, 32) sufficient to accomplish the purpose for which each particular spoke system is intended. Accordingly, the spoke systems 14, 16 do not require expensive control, support, and operations system components infrastructure—which resides at the hub system 12.

While the COI may be implemented in a variety of ways such as utilizing basic client/server software solutions (for example with the server portion of the software residing at the hub system 12, while client software modules are provided for the spoke systems 14, 16 to enable communication with the hub system 12, preferably, the COI of the inventive DDP system 10 is implemented using more powerful and advantageous approaches, such as modular distributed software solutions that are cross-platform, that utilize techniques such as common language runtime, function libraries, and that rely on virtual runtime machines to perform various hub and spoke services, and on local client interfaces for system management and work functionalities.

Such COI solutions have a number of significant advantages (described in greater detail below), including, but not limited to the following:
1. Security—centralized system-wide security policies, “chain-of-custody” control over data (for example, sensitive data may be only temporarily shown to users of the spoke systems during performance of work relating to the data, and never actually saved a the spoke sites), and instant control over security clearances and authority levels of all users of the DDP system 10;
2. Elimination of individual client software applications at the spoke systems that would otherwise need to be supported and kept up-to date;
3. Reduction in required power and expense of certain types of spoke system components to a point where a spoke system may be implemented in a portable or even a pocket computer; and
4. Instant propagation of any changes in the target task(s) or business practices, across the entire DDP system 10 by centralized modification of the COI that optionally causes corresponding automatic changes in hub and/or spoke services.

Preferably, the COI, in conjunction with the communication links 18, 20, and appropriate hub and spoke system components and services, is configured to take advantage of ready availability of high speed and high bandwidth communication links to enable cost-effective transfer of data and work between the spoke systems 14, 16 and the hub system 12 dynamically, and preferably in real-time. This arrangement enables various DDP system 10 operations to be performed at the spokes and hub simultaneously and without any loss of throughput. Furthermore, implementation of real-time or near-real time COI functionality brings many other advantages to the DDP system 10, such as, real-time load balancing, and workflow management and optimization (predictive queuing, etc.). At least some of these advantages are described in greater detail below in connection with FIGS. 2 to 9B.

While the above-described COI implementation solutions are beneficial, it should be noted that as long as key purposes and principles of the COI, as described above, are supported, the COI of the DDP system 10 may be readily implemented in virtually any current or future data processing operating environment and/or platform as a matter of design choice or necessity, without departing from the spirit of the invention.

The following simplified example may be useful to illustrate potential operations and configuration of a novel DDP system 10 utilized in the field of lockbox processing services. In this example, the designated purpose of the spoke system 14 is check data collection, the designated purpose of the spoke system 16 is data entry and correction (e.g., scanline fix, etc.), and the designated purpose of hub system 12 is to manage the flow of data and work to and from the spoke sites 14, 16, to apply final processing to the completed work (e.g., transaction balancing), to store the data and work, and/or optionally to transmit the data and/or work to a third party (e.g., the customer organization).

The spoke system 14, is thus located in a region convenient for customer check collection, and includes spoke system components 26 and services 28 selected and configured for obtaining check image data, check data encoding, optical character recognition, and image data transmission. The spoke system 16 is located in a region with low labor costs, and includes spoke system components 26 and services 28, selected and configured for receiving and displaying check images and related data to the users and for enabling multiple users to simultaneously perform the necessary work (e.g., amount entry, scanline fix, etc.). The hub system components 22 include one or more computer servers for system 10 management, workflow regulation, and processing of acquired data and work, a data storage system, and communication routing components. The DDP system 12 of this example operates as follows:
1. Checks are scanned and processed at the spoke system 14 to obtain “acquired data”—check images and encoding information (and optionally OCR data)
2. The acquired data is transmitted to the hub system 12, where it may be modified (e.g., with additional encoding, OCR operations, and compression), and then temporarily routed to the spoke site 16 in real-time (or near real-time) in accordance with predefined workflow rules (for example that take into account individual productivity and skills of the users of the spoke system 16).
3. Users of the spoke system 16 perform various tasks utilizing the received data (e.g., scanline fix, amount entry, etc.) to produce work data (e.g., electronic database records of check transactions) and then the work data is transmitted back to the hub system 12, while the received data is automatically purged for security purposes when receipt of the work data is verified at the hub system 12.
4. At the hub system 12, the received work data is subjected to additional processing (e.g., the check transactions are reconciled and balanced)—a task that may be partially or entirely relegated to a different group of users at the spoke system 16, or to an additional spoke system (not shown). The final work data is then stored at the hub system 12 and partially or entirely transmitted to a third party (e.g., a customer or a transaction clearinghouse).

Various exemplary embodiments of novel spoke system 14, 16 configurations are shown and described below in connection with FIGS. 2, 3A and 3B, while an exemplary embodiment of the hub system 12 is shown and described below in connection with FIG. 4.

Referring now to FIG. 2, a first exemplary embodiment of a spoke system 50 (for example corresponding to one or both of the spoke systems 14, 16 of FIG. 1) is shown. As noted above, the specific spoke system components and spoke services of the spoke system 50 are shown in FIG. 2 and described herein by way of example only, to illustrate the possible spoke system options that may be selected and configured to perform specific tasks. In fact, the exemplary spoke system 50 intentionally shows many more types of spoke system components and spoke services than may be advantageously utilized at a single spoke site to demonstrate as many examples of each as possible.

Furthermore, only system components and services relevant to the operation and novel features of the DDP system 10 are shown and described. In practice, there may be many additional background components and services that are included in the spoke system 50 portion of the DDP system 10, that support its operation, but that are not relevant to its inventive features, and accordingly are not shown or described herein for the sake of simplicity.

The spoke system 50 includes spoke system components 52 and spoke services 54 (for example, corresponding to components 26, 30 and services 28, 32 of FIG. 1) and an optional spoke_ID 82 that contains information that identifies the spoke 50 to its corresponding hub system (e.g., hub system 12 of FIG. 1), and that may optionally contain additional information about the spoke components, services, the capabilities and skill sets of the spoke users, and any other spoke-related information. This extended embodiment of the spoke_ID 82 may be particularly useful in cases where the spoke system 50 is added as a new spoke to the DDP system 10 without preparation at the hub system 12 (as may be the case in an emergency, or as part of disaster recovery or failsafe procedures).

Preferably, unless there are other considerations (for example, if the spoke system 50 has other purposes, such as working with different hub systems on a different shift, or performing other local tasks), it may be advantageous to simplify the COI and minimize the expenses, by ensuring that the spoke system components 52 are the minimum necessary (with a margin for unforeseen events) in capability, scale, and capacity to accomplish the designated purpose of the spoke system 50 assigned thereto by the DDP system 10. As a matter of design choice, a particular spoke system 50 may include more or less spoke system components and services, or may include entirely different components and services depending on the designated purpose of the spoke system 50.

The spoke system components 52, may include, but are not limited to one or more of following components:
A computer system 56, which may range from a portable or pocket computer, to a cluster of computer servers depending on the spoke services 54 that the spoke system 50 is configured to deliver,
A user authentication system 58 for verifying the identity of the users of the spoke system 50, that may range from a card reader, to a biometric scanner (for example based on fingerprint, palm, face, retinal or DNA recognition),
A data entry system 60, for example a terminal with a display and an input device, that enables the user to perform the required data entry services,
A data acquisition system 62, for acquitting data necessary for the DDP system 10 operation, which depends on the designated purpose of the spoke system 50, and on the type of data it is required to collect. For example, the data acquisition system 62 may be one of the following:
   an image scanner, or one or more scanning systems,
   audio/visual capture devices (e.g. microphones, cameras),
   medical and/or scientific instruments or sensors, or
   a data feed (e.g., stock exchange trading information) receiving device
A data pre-processing/handing system 64 for performing one or more predefined procedures on the acquired data before transmission to the hub system, depending on the type of data acquired and additional considerations (such as operational rules). For example, the data pre-processing/handing system 64 may verify, modify (e.g., compress), analyze, encrypt, or perform operations such as OCR on scanned documents. Optionally the data pre-processing/handing system 64 may include real time data transmission management capabilities;
Additional systems 66 which may include any other system components necessary for spoke system 50 operations; and
A communication system 68 configured to enable bi-directional communication (i.e., transmission of data, work, and COI instructions) between the spoke system 50 and the hub system (e.g., the hub system 12 of FIG. 1)

As noted above, certain system components may be physically implemented as a physical sub-components or as functions/services of another particular system component. For example, the data entry system 60 may be readily implemented a part of the computer system 56, while the user authentication system 58 may be a physical sub-component (e.g., a biometric scanner integrated into the computer system 56), or it may be implemented as a security service through username/password protection or the like.

The spoke services 54, may include, but are not limited to one or more of followings services, each performed by one or more of the spoke system components 52, at the spoke system 50 locally, or in conjunction with the hub system:
A user interface service 70 that enables the users to access the relevant spoke system components 52 and thus utilize the corresponding spoke services 54. The interface service 70 may vary depending on the purpose of the spoke system 50, on the types of work or other tasks that can performed therethrough, on the work assignments of particular users of the spoke system 50, and, optionally, on authority levels of specific users. The user interface service 70 may range from a standard internet browser to a “smart client” at the computer system 56,
A data acquisition service 72 corresponding to the functionality of the particular data acquisition system 62;
A data entry service 74 corresponding to the functionality of the particular data entry system 60;
A user work functions service 76 that includes support for any and all work that may be done by any of the users of the spoke system 50 with respect to the data received from the hub system. Thus, in essence the data entry service 74 falls under the work functions service 76. The exemplary types of work may be performed by the users of the spoke system 50 are described in greater detail in Table 1 above;
A query/reporting/monitoring service 78, for enabling authorized users and local administrations or management personnel with appropriate permissions, to monitor, investigate, and produce reports relevant to the operation of the DDP system to which the spoke system 50 belongs, or any part thereof (for example, information relating to the spoke system 50 or any of its spoke system components 52, and spoke services 54, to the hub system connected to the spoke system 50, and optionally, information relating to other spokes that are part of the connected DDP system); and
Additional services 80 which may include any other services necessary for spoke system 50 operations (that may be performed by one or more of the additional systems components 66).

As noted above, certain spoke services may be optionally performed/managed as part of other spoke services. As noted before, the specific selection and configuration of one or more spoke services 54 may be advantageously controlled by an authorized administrator at the hub system by making changes to the COI settings specific to the spoke services 54.

Referring now to FIGS. 3A and 3B, two exemplary alternate embodiments of the spoke system 50 are shown as spoke systems 100 and 150, respectively with the various elements shown in the, figures being equivalent to identically named elements in FIG. 2, and described in greater detail above. The spoke systems 100 and 150 illustrate the possible differences between different spoke systems of a DDP system 10—the spoke system 100 includes spoke system components 102 and corresponding spoke services 104 configured for data acquisition, while the spoke system 150 includes spoke system components 152 and corresponding spoke services 154 configured for performing work related to data (e.g., entry, analysis, modification). The exemplary spoke systems 100, 150 correspond to the embodiments of the spoke systems 14, 16, respectively, of FIG. 1 in connection with the description of exemplary operation of the inventive DDP system 10 configured to provide lockbox processing services.

Referring now to FIG. 4, an exemplary embodiment of a hub system 200 (for example, corresponding to the hub system 12 of FIG. 1) is shown. As noted above, the specific hub system components and hub services of the hub system 200 are shown in FIG. 4 and described herein by way of example only, to illustrate the possible hub system options that may be selected and configured to support the COI in performance of the target tasks(s), and management of the DDP system to which the hub system 200 belongs.

Furthermore, only hub system components 202 and services 204 relevant to the operation and novel features of the DDP system 10 are shown and described. In practice, there may be many additional background components and services that are included in the hub system 200 portion of the DDP system 10 and support its operation, but that are not relevant to its inventive features, and accordingly are not shown or described herein for the sake of simplicity.

The hub system 200 includes hub system components 202 and hub services 204 (for example, corresponding to hub system components 22 and hub services 24 of FIG. 1). Preferably, unless there are financial or other considerations to the contrary, the hub system components 202 are selected and configured to provide the best possible support for the COI to enable the DDP system 10 to meet or exceed the target task performance expectations. This may be accomplished, for example, by providing centralized DDP system 10 management, and by maximizing capability, scale, and capacity of the hub system components and performance and efficiency of the hub services 204, and by centralizing as many information system infrastructure-heavy services as possible at the hub, as hub services 204, to be performed by the hub system 200. Nevertheless, as a matter of design choice, a particular hub system 200 may include more or less hub system components and services, or may include entirely different hub system components and/or hub services depending on the target task(s) of the DDP system 10.

The hub system components 202 may include one or more hub operations system components 206 responsible for performing hub services 204, and/or for interaction with spoke services, and one or more hub storage system components 208, responsible for storing acquired data, work data received from the spoke systems (e.g., spoke systems 14, 16 of FIG. 1 or spoke systems 100, 150 of FIGS. 3A and 3B, respectively), and configuration and operation data utilized by the COI during the DDP system 10 operations. The hub operations system components 206 and the hub storage system components 208, may be implemented in two separate groups connected to one another by a communication link (not shown). This arrangement may be advantageous, if the hub storage system components 208 must be located in a secure, protected area,. Optionally, both components 206 and 208 may be implemented as a single set of hub system components 202, in which case one of the communication systems 220, 228 may be eliminated as a matter of design choice.

The key component of the hub operations system components 206 is a server system 210, which may range from a single high capacity computer server to one or more server clusters (i.e., groups of independent servers managed as a single system for higher availability, manageability, and scalability) as dictated by the operational requirements of the DDP system 10. A server cluster is a parallel or distributed system that consists of a collection of interconnected separate computer systems, that is utilized as a single, unified computing resource. For intensive target tasks one or more server clusters are the preferred implementation for the server system 210, because one of the goals of a server cluster is enable sharing of a computing load over several systems transparently to users and system administrators. If any component in the server cluster system hardware or software fails, the overall DDP system 10 performance may degrade, but the hub and spoke systems, the users and administrators will not lose access to the hub and spoke system services. Ideally, if more processing power is needed, when for example a new spoke system is added, a new component may be readily added to the server system 200 to improve the overall performance of the DDP system 10.

Utilization of advanced DDP system 10 operating software (which interfaces with or is incorporated by the COI) with enhanced symmetric multiprocessing (SMP) at the server system 210, also enables use of high performance servers that are capable of utilizing multiple processors and additional expanded memory capacity to achieve increased server scalability. Depending on the specific implementation of the COI, the server system 210 may be entirely or partially configured as a web server to enable smoother scalability of the DDP system 10 as new spoke systems are added.

Because the hub system 200 is responsible for the mission-critical operations as well as for the most intensive processing activities, the reliability of the server system 210 is crucial. Server clusters implementation (as described above) of the server system 210, supplied with cluster server management services enables increased overall reliability of the DDP system 10. For example the server system 210 can automatically detect the failure of a service, for example due to a hub 200 component problem, and quickly restart the service on an alternate component. Users will not experience more that a momentary pause in service. In addition, hub administrators can quickly inspect the status of all cluster resources, and move the workload onto different servers within the cluster. This approach is not only useful for automated load balancing and workflow handling services, but also for manual load balancing, and for performing “rolling updates” on the server system 210 servers, without taking important data and applications offline.

While in most cases the server system 210, especially in a cluster configuration, provides all necessary processing capabilities for the hub system 200, in certain applications, the hub system operations components 206, may also include a separate control system 212 for controlling the operations of the hub system 200 and the DDP system 210, that may be more secure or reliable than the server system 210, or that may need to be located at a remote site, and/or a separate data/work processing system 214, which may be a dedicated computer system or set of computer systems (e.g., a super computer or supercomputer cluster) for performance of particularly computation-intensive services, such as meteorological forecasting, scientific data analysis, or complex military intelligence analysis.

The hub system operations components 206, may also include, but are not limited to, one or more of following components.
A security system 216 providing hardware-based security for the hub system 200 and the DDP system 10, for example in form of a dedicated identity verification server systems, local biometric scanners, or dedicated encryption hardware.
Additional systems 218 which may include any other system components necessary or advantageous for hub system 200 operations (for example, the additional systems 218 may include spoke system components for emulation of the functionality of one or more spoke systems at the hub system 200, which may be advantageous in case of an emergency; and
A communication system 220, that is configured to enable bi-directional communication (i.e., transmission of data, work, and COI instructions) between the hub system 200 and the various spoke systems (e.g., the spoke systems 14, 16 of FIG. 1). Preferably, the communication system 220 includes high speed data routing and switching capabilities, in conjunction with security features (that may optionally be partially or entirely provided by the security system 216), to maximize the volume, security, and speed of data interchange between the spoke systems and the hub system 200, thus enabling distributed data processing over the entire DDP system 10 without compromising the confidentiality of confidential data.

As noted above, certain hub operations system components 206 may be physically implemented as a physical sub-components or as functions/services of another particular system component.

The hub storage system components 208 is responsible for securely storing large amounts of data, and for ensuring fast and reliable access to the stored data. The hub storage system components 208 may be implemented as a storage area network (SAN)—a high-speed network of shared storage devices that can be made available to all servers in the server system 210, or to computer systems 212 and 214, or made available to other hub system 200 components and/or services over a communication link 228. A SAN is a high-speed special-purpose network (or sub-network) that interconnects different kinds of data storage devices with associated data servers (e.g., the server system 210) on behalf of a larger network of users. A SAN allows for additional hub system 200 reliability, as it supports services such as data mirroring, backup and restore, archival and retrieval of archived data, data migration from one storage device to another, and the sharing of data among different hub system 200 components.

While the hub storage system components 208 may be implemented as a SAN, optionally, it may be spilt into separate data storage components dedicated to different types of services, each of which may be a SAN in itself or may be any other form of data storage. In such a configuration, the hub storage system components 208 may include an acquired data storage system 222 for storing large volumes of data acquired from spoke systems, a work storage system 224 for storing work data received from the spoke sites, and/or work data resulting from processing by the server system 210, or by the data/work processing system 214. The hub storage system components 208 may also include a configuration and operation parameter storage (COPS) system 226. The COPS system 226 is responsible for storing the COI/DDP system settings, configuration schemes, operational parameters, rules and other information crucial for the operation of the DDP system 10 and its elements (i.e., the hub and the spoke systems). Depending on the target task(s) of the DDP system 10, each type of storage system may be implemented in a customized manner with different security and reliability safeguards and different performance characteristics.

Finally, if they are positioned remotely or separately from the hub operations system components (esp. the server system 210 and optional computer systems 212, 214) the hub storage system components 208 may also include an optional communication system 228, that is configured to enable bi-directional communication (i.e., transmission of data, work, and COI instructions) between the hub storage system components 208 and the appropriate hub operations systems components 210, 212 and/or 214 Preferably, the communication system 228 includes high speed data capabilities in conjunction with security features.

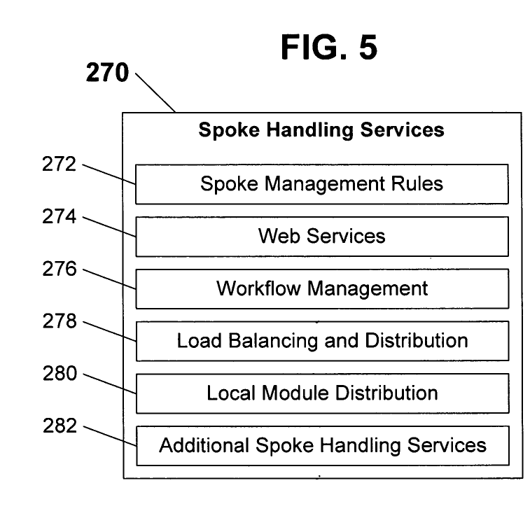

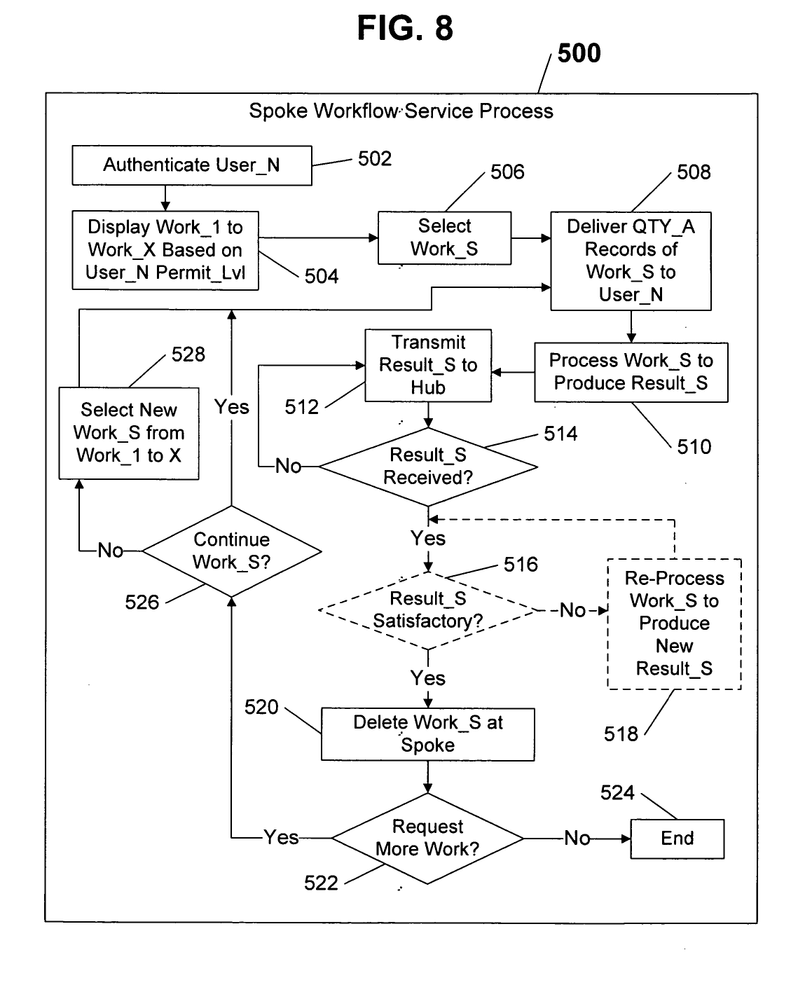

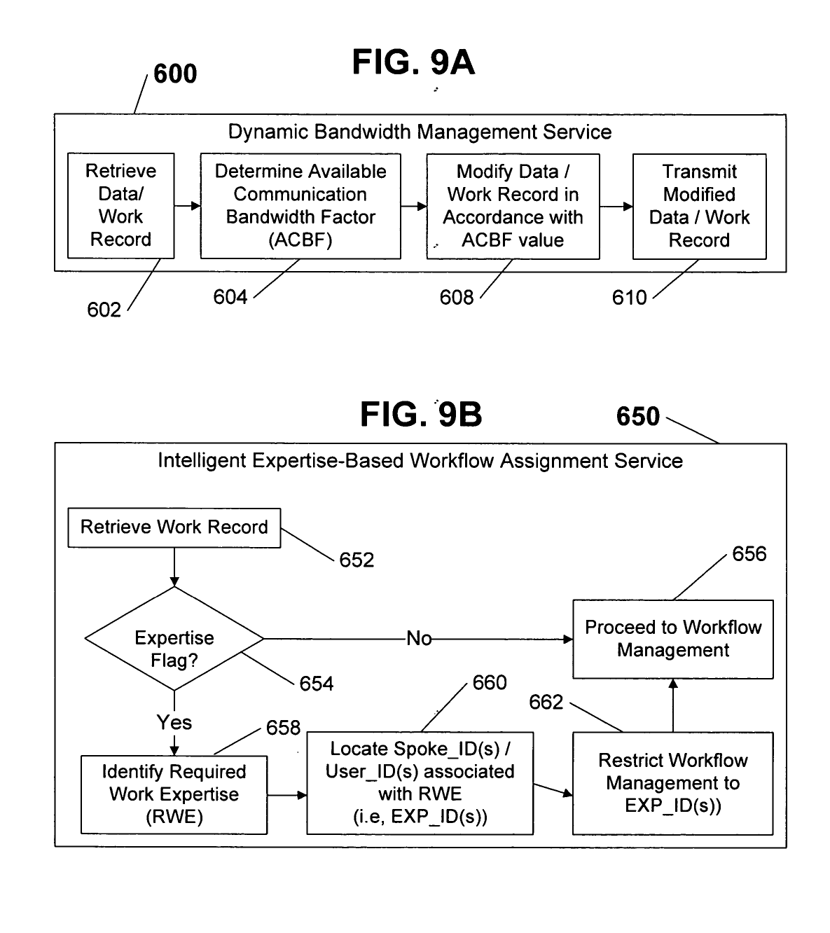

The hub services 204, may include, but are not limited to one or more of followings services, each performed by one or more of the hub system components 202, at the hub system 200 locally, or in conjunction with one or more of the spoke systems:
An administrator interface service 260 that enables the administrator(s) to access the various COI and DDP system 10 (including hub system 200 and spoke systems) control and configuration services. The interface service 260 and its functionality may vary depending on the configuration of the DDP system 10, on the target task(s), and on authority levels of specific administrators.
A spoke handling service 232 that handles the crucial task of interaction between the hub system 200 and the various spoke systems, to ensure smooth and efficient operation of the DDP system 10. Referring now to FIG. 5, an exemplary embodiment of the types of specific services that may be included in spoke handling services 270 is shown. The spoke handling services 270 may include one or more of the flowing services:
   Spoke management rules 272—for governing spoke system—related services of the DDP system 10, for example for switching between spokes, for disaster recovery, etc.
   Web services 274—for implementing desired hub services 204 on the internet as part of the COI.
   Workflow management service 276—for managing the flow of data received from the spoke systems, for sending data to specific spoke systems to be worked on, for receiving work data, and for all supporting services. Optionally, the workflow management service may be implemented with intelligent features, such as the intelligent expertise-based workflow assignment service 650 discussed in greater detail below in connection with FIG. 9B.
   Load balancing and distribution service 278—for managing the selection of specific spoke systems for automatic, semi-automatic, or manual spoke system load balancing.
   Local module distribution service 280—for ensuring delivery of all necessary application programs to the spoke system in certain client-server COI implementations when the spoke systems require client modules to interact with the hub system 200.
   Additional spoke handling services 282—for performing any other spoke-related management functions from the hub system 200.

Returning now to FIG. 4, the hub services may also include one or more of the following services:
A load handling service 234, that performs load balancing operations on the hub system 200, corresponding to the functionality of the load distribution features of the server system 210;
An error handling service 236, that handles certain types or all system component and/or service errors that may occur during the operation of the DDP system 10;
A security service 238, that manages all security operations of the DDP system 210, in accordance with the functionality of the security system component 216;
A compliance service 240, for ensuring that all DDP system 10 operations are in compliance with applicable organizational policies, business rules, and/or regulatory requirements;
A configuration service 242, for enabling administrators, utilizing the administrator interface service 260, to control various COI and DDP system 10 (including hub system 200 and spoke systems) configuration settings;
A spoke functions service 244, that enables emulation or replication of the functionality of one or more spoke systems locally at the hub system 200, which may be advantageous in case of an emergency;
Additional services 246, that may include any other services necessary for hub system 200 operations (that may be performed by one or more of the additional systems components 218).
Work and acquired data handling and processing services 248, 250, 252, and 254, respectively, that are responsible for receipt, transmission, verification, integrity, and storage of the acquired and work data generated during the operation of the DDP system 10.
A query/reporting/monitoring service 256, for enabling authorized users and administrations, or management personnel with appropriate permissions, to monitor, investigate, and produce reports relevant to the operation of the DDP system to which the hub system 200 belongs, or any part thereof (for example, information relating to the hub system 200 or any of its hub system components 202, and hub services 204, and to the spoke systems connected to the hub system 200; and
Policies (Operations, Business, Regulatory) service 258, that enables definition and application of an organization's or regulatory policies, as well as business rules to DDP system 10 operations

As noted above, certain hub services 204 may be optionally performed/managed as part of other hub services. The proper selection, configuration, and utilization of the various hub services 204 is important in achieving or exceeding potential target task performance goals by the DDP system 10. The specific selection and configuration of one or more hub services 204 may be advantageously controlled by an authorized administrator at the hub system by making changes to the COI settings specific to the hub services 204, for example by accessing the configuration service 242 through the administrator interface 260.

Referring now to FIG. 6. an alternate embodiment of the DDP system 10 of FIG. 1, is shown as a DDP system 300, to illustrate an exemplary implementation of a more robust DDP system for performance of complex target task, for example having three separate sub-tasks A, B and C. The DDP system 300 includes a hub system 302, a spoke system 304 configured for performing the first designated sub-task A, and connected to the hub system 302 via a communication link 310, a first group of spoke systems 306, all configured for performing a second designated sub-task B, and connected to the hub system 302 via a communication link 312, and also includes a second group of spoke systems 308, all configured for performing a third designated sub-task C, and connected to the hub system 302 via a communication link 314. The hub system 302 is shown with a server system cluster (such as the server system 210 of FIG. 4), as well as two separate work processing system components (such as the hub component 214 of FIG. 4), as well as other hub system components.

The novel architecture of the DDP system 300 is advantageous in a number of ways, for example, a complex and/or sensitive sub-task A may be routed by the hub system 302 to a special spoke system 304 via a dedicated communication link 310, while other sub-tasks B and C may be readily distributed and/or balanced between the individual spoke systems in each of the groups 203, 308.

Preferably, the COI of the DDP system 300, in conjunction with the appropriate communication links 310, 312, and 314, and appropriate hub and spoke systems components and services, is configured to take advantage of ready availability of high speed and high bandwidth communication options to enable cost-effective transfer of data and work between the spoke system 304, the spoke systems in spoke groups 308, 308 and the hub system 302 dynamically, and preferably in real-time or in near-real-time.

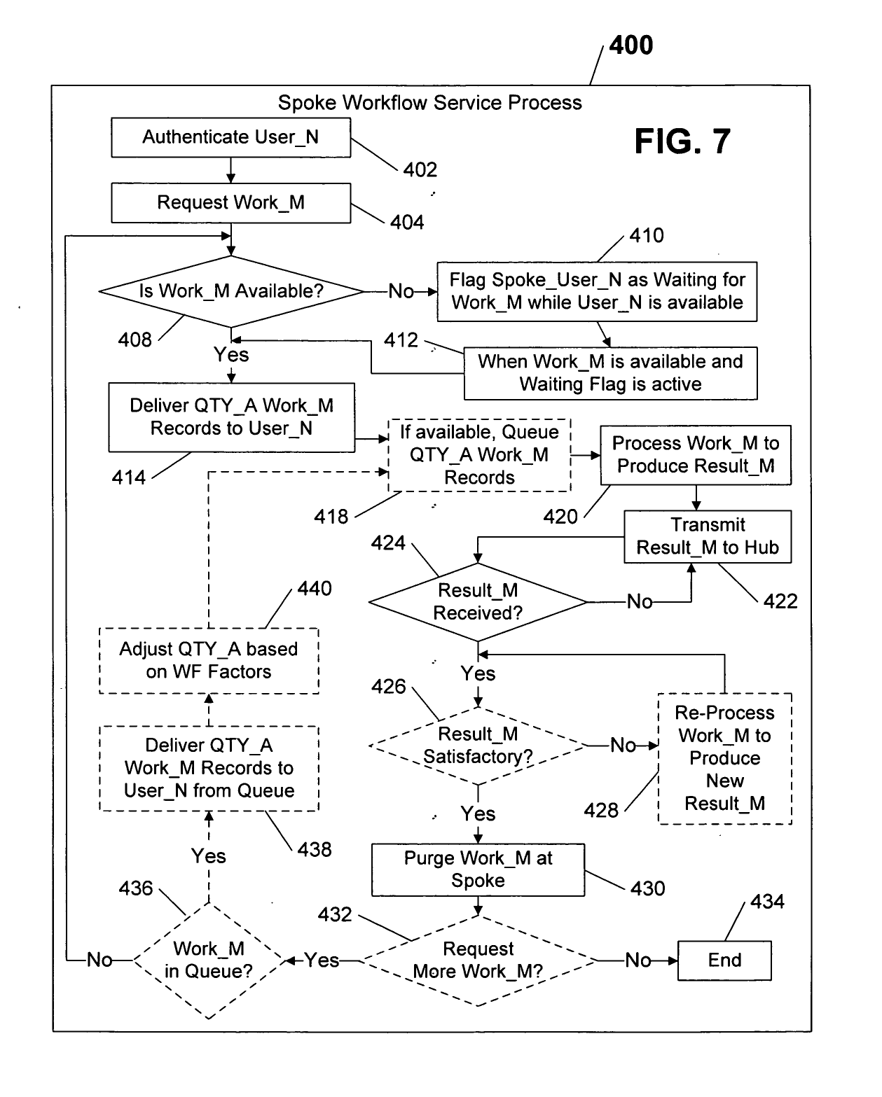

Referring now to FIG. 7, a first embodiment of an exemplary portion of a workflow service (e.g., the workflow management service 276 of FIG. 5) in which work to be performed at a spoke system is requested by a user at a spoke system indicating their availability, is shown as a spoke workflow service process 400, with certain steps being performed by the user at a spoke system (e.g., any of the spoke systems described in the previous figures), other steps being performed by a hub system (e.g. any of the hub systems described in the previous figures) at the spoke system remotely, and certain steps being performed by the hub system at the hub. It should be noted that the various steps of the process 400 are shown and described by way of illustrative example only and may vary depending on specific workflow service implementations, on the types of data and work, and on the configuration of the spoke and hub systems. For the sake of convenience, the various letters N, M, and A are used as “wildcard” variables in FIG. 7 to identify a specific user (e.g., User_N,), a specific work task (e.g., Work_M), and a specific quantity of work tasks (QTY_A).

The process 400 begins at a step 402 when the User_N (e.g., a user at a particular spoke system) is authenticated and allowed access to one of the hub system workflow services. At a step 404, the User_N requests specific Work_M (for example work that the User_N is authorized and qualified to do). Steps 408 to 414 determine if the requested Work_M is available, if it is, the process 400 delivers a certain predetermined quantity (QTY_A) of Work_M records to the User_N, and otherwise keeps track of the availability of User_N and delvers the Work_M as soon as it appears in the workflow, assuming the User_N is still available. At an optional step 418, the process may also queue an additional QTY_A of Work_M records if they are available so that they can be instantly sent to the User_N as soon as the current Work_M records are completed. Optionally the User_N may have a unique identifier indicative of productivity with respect to the specific Work_M, and the initial QTY_A is then preferably appropriately adjusted.

At a step 420, the User_N completes any tasks related to the Work_M (i.e., “processes” the Work_M) and the process 400 transmits the corresponding Result_M to the hub system at a step 4220. At steps 424 and then 430, the hub system verifies that the Result_M has in fact been received, and then purges the Work_M (and optionally Result_M) at the spoke system.

For certain types of Work_M additional optional steps 426 and 429 may be necessary between the steps 426 and 430, in which the hub system checks the Result_M quality before accepting it, and forces the User_N to rework the Result_M until it is acceptable (or for a specified number of times before generating an “exception” or error. (not shown). The process then ends at a step 434.

Alternately, if the workflow continues for multiple user sessions, optional steps 432 to 440 may be performed to determine if additional Work_M is requested by the User_N after QTY_A of the Work_M records have been completed and sent to the hub system. If additional Work_M is requested, then the process 400 either checks for availability of Work_M, if the queue is empty, and otherwise queues QTY_A of work records to the user. Optionally, the process 400 may include dynamic predictive queuing by constantly updating and changing (as necessary) the QTY_A of Work_M records that are queued to the User_N based on various workflow factors (WF factors), such as the user's expertise and performance and overall DDP system conditions.

Referring now to FIG. 8, a second embodiment of an exemplary portion of a workflow service (e.g., the workflow management service 276 of FIG. 5) in which work to be performed at a spoke system is selected by a user at a spoke system from a list of available work tasks, is shown as a spoke workflow service process 500, with certain steps being performed by the user at a spoke system (e.g., any of the spoke systems described in the previous figures), other steps being performed by a hub system (e.g. any of the hub systems described in the previous figures) at the spoke system remotely, and certain steps being performed by the hub system at the hub.

It should be noted that the various steps of the process 500 are shown and described by way of illustrative example only and may vary depending on specific workflow service implementations, on the types of data and work, and on the configuration of the spoke and hub systems. For the sake of convenience, the various letters N, S, A, and X are used as “wildcard” variables in FIG. 8 to identify a specific user (e.g., User_N,), a specific work task (e.g., Work_S), a specific quantity of work tasks (QTY_A), and a specific range of available Work_S records (X).

The process 500 begins at a step 502 when the User_N (e.g., a user at a particular spoke system) is authenticated and allowed access to one of the hub system workflow services. At a step 504, the User_N is presented with a list of available work tasks (i.e., Work_{—}1 to Work_X) based on the User_N's Permit_Lvl (clearance, skill set, etc.), and at step 506, the User_N selects a specific Work_S. The steps 508 to 522 proceed identically to the steps 414, and 416 to 434, respectively. At a step 526, the User_N decides if they will continue working on additional Work_S records, or whether a different set of Work records are to be selected.

The process 500 provides an alternative workflow management technique that places some control in the hands of spoke system users with regard to which work tasks the users perform. Optionally, the predictive queuing steps 438, 440 of FIG. 7 may be readily utilized in the process 500, if Work_S is of the type suitable for queuing.

Referring now to FIGS. 9A and 9B, exemplary embodiments of two advantageous inventive hub system services (such as may be included in the hub services 204 of FIG. 4) are shown. In FIG. 9A, a dynamic bandwidth management (DBM) service is shown as a process 600 for dynamically modifying data and/or work records received from and sent to the various spoke systems is shown to compensate for up-to-date drops in communication link bandwidth availability. The DBM service process 600 may operate as a sub-service of the spoke handling service 232 or of the data and/or work handling services 248, 252. At a step 602, the process 600 retrieves a data or work record, at a step 604, the process determines the available communication bandwidth factor (ACBF) based on the status of the communication link through which the data or work record is to be transmitted. At a step 608, the process modifies the data or work record in accordance with the value of the ACBF, for example by compressing it or only sending the portions of the data necessary for spoke system users who will be working with the transmitted data, and transmits the modified data/work record at a step 610.

The DBM service 600 is advantageous because it enables the hub system to continue to operate at maximum possible speed and capacity (e.g., in real-time) even during drops in communication link bandwidth.

In FIG. 9B, an intelligent expertise-based workflow assignment (IEBWA) service is shown as a process 650 for ensuring that certain types of flagged work records are automatically assigned to certain specific spoke systems and/or even particular users at one or more spokes based on predefined expertise at the spoke system level, at the user level, or both. The IEBWA service process 650 may operate as a sub-service of the spoke handling service 232. At a step 652, the process 650 retrieves a work record, at a step 654, the process determines whether the work record includes an expertise flag, and at a step 656 passes the work record to regular workflow management services if it does not.

If the expertise flag is present, at a step 658, the process 650 identifies the specific required work expertise (RWE) and at a step 660 locates the spoke systems having the corresponding RWE associated with their Spoke_ID, or users at one or more spokes with corresponding RWE associated with their User_ID, or both to identify one or more experts (EXP_ID(s)). At a step 662, the process 650 restricts the rest of the workflow management services to ensure that the flagged work record is sent only to one of the spoke systems and/or uses with the EXP_ID located at the step 660. Optionally, at the step 662, an administrator may manually assign the work record to a particular EXP_ID. Alternately, the EXP_IDs of certain spoke systems and/or users may include a value representative of their degree of expertise, and the step 662, may further include a step of ranking the Spoke_IDs and User_ID by that value.

The IEBWA service is particularly advantageous in cases where the target tasks or sub-tasks thereof are complex and require specific expertise for the user. This would include scientific, medical, law enforcement, military, and even entertainment applications (such as large scale special effects productions or digital animation work). However, this service can also be very important in even conventional lockbox service applications for example to ensure that serious errors or exceptions are resolved by users with specific expertise in the subject.

It should be readily apparent that the novel DDP system 10 may be advantageously used for performance of virtually any data-related target task. As noted throughout Table 1, above, the novel DDP system 10 or 300, me readily implemented for any form of document processing (e.g. ranging from non=profit donation cards or mail order forms and reply cards, to invoices, checks and other financial instruments, or medical insurance explanation of benefits forms), the processing and collection of medical and/or scientific data, law enforcement, military and other government applications, and even such tasks as theatrical animation or digital special effects work (rendering, modeling, etc.).

Thus, while there have been shown and described and pointed out fundamental novel features of the invention as applied to preferred embodiments thereof, it will be understood that various omissions and substitutions and changes in the form and details of the devices and methods illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto.

1. A data processing system for distributed execution of at least one predefined target task, the at least one predefined target task having target task information associated therewith, comprising:
at least one remote processing system, located at a corresponding at least one satellite site having at least a portion of the target task information located therein, said at least one remote processing system being operable to perform at least one predefined first operation on said at least a portion of the target task information, to produce initial work data;
a central hub system, located at a central hub site, remote from said at least one satellite site, operable to:
(a) receive said initial work data from said at least one local processing system, and
(b) automatically apply at least one predetermined data processing function to said initial work data to produce result data representative of a successful execution of the at least one predefined target task; and
communication means, for connecting said central hub system to said at least one local processing system to enable transfer of said initial work data from said at least one satellite site to said central hub site.

2. The data processing system of claim 1, further comprising at least one additional remote processing system, connected to said central hub system via said communication means, wherein instead of automatically applying said at least one predetermined data processing function to said initial work data, said central hub system is operable to transmit said initial work data to said at least one additional remote processing system, wherein said at least one additional remote processing system is operable to perform at least one predefined second operation on said initial work data to produce said result data, and wherein said central hub system is further operable to receive said initial work data from said at least one additional local processing system.

3. The data processing system of claim 1, wherein said at least one predefined first operation comprises acquisition of at least a portion of the physical target task information into electronic form.

4. The data processing system of claim 1, wherein said at least one data processing operation comprises generation of at least one electronic record representative of the target task information.

5. The data processing system of claim 1, wherein said central control system comprises at least one computer server unit.

6. The data processing system of claim 5, wherein said at least one server unit comprises a plurality of interconnected server units forming a server cluster, and wherein said server cluster further comprises operating environment software operable to provide server reliability, load balancing and scalability functions thereto.

7. The data processing system of claim 1, wherein said at least one predefined first operation comprises capturing said target task information through at least one of the following operations: image scanning, power encode pass, and image recognition.

8. The data processing system of claim 1, wherein said at least one predefined task is lockbox transaction processing.

9. The data processing system of claim 1, wherein at least one of said central control system and said at least one local processing system, further comprises data entry system means for generating at least a portion of the result data.

10. A data processing system for distributed execution of at least one predefined task, comprising:
at least one local processing system, located at a corresponding at least one satellite site, operable to perform at least one predefined data acquisition function on task data, representative of the at least one predefined task, said task data being present at said corresponding at least one satellite site, to produce initial work data;
a central hub system, located at a central hub site geographically remote from said at least one satellite site, operable to:
(a) receive said initial work data from said at least one local processing system, and
(b) automatically apply at least one predetermined transaction processing function to said initial work data to produce transaction data representative of successful completion of the at least one predefined task; and
communication means for connecting said central hub system to said at least one satellite system, to enable transfer of initial work data from said at least one satellite site to said central hub site.

11. The data processing system of claim 1, wherein at least one local processing system further comprises data capture means for capturing task data, and wherein said at least one predefined data acquisition function comprises at least one of: image scanning, power encode pass, and image recognition.

12. The data processing system of claim 1, wherein said at least one predefined task is lockbox transaction processing.

13. The data processing system of claim 1, wherein at least one of said central hub system and said at least one local processing system, further comprises a data entry system for entering initial work data into the central hub system.
